(19) United States
(12) Patent Application Publication
(10) Pub. No.: US 2012/0228118 A1
(43) Pub. Date: Sep. 13, 2012

(54) METHOD AND EQUIPMENT FOR TREATMENT OF BLACK LIQUOR AT PULP MILL

(76) Inventor: Timo Honkola, Ruutana (FI)

(21) Appl. No.: 13/505,507

(22) PCT Filed: Nov. 2, 2010
(86) PCT No.: PCT/FI2010/050872

§ 371 Date: May 22, 2012

(30) Foreign Application Priority Data
Nov. 6, 2009 (FI) 20096152

(51) Int. Cl. B01D 3/36

(52) U.S. Cl. 203/27; 203/31; 202/202; 202/197

(57) ABSTRACT

The invention relates to a method and equipment for treating pulp mill black liquor so as to recover the energy in chemicals therein. In the invention the black liquor is pyrolysed in a pyrolysis reactor (4), where causticizing material consisting of metal oxide and sodium oxide and heated in a burning unit (6) is conveyed, and gaseous components formed in pyrolysis are conveyed for utilization and solids are returned to the burning unit.

### BACKGROUND OF THE INVENTION

The invention relates to a method for treating pulp mill black liquor in order to recover chemicals and energy contained therein. The invention further relates to equipment for treating pulp mill black liquor in order to recover chemicals and energy contained therein.

A pulping process treats wood material, generally wood-chips, by means of heat and chemicals by cooking it in a chemical solution containing, inter alia, lye. This is called pulp cooking. The object of the treatment is to remove fibre-binding lignin. In soda cooking the cooking chemical is expressly sodium hydroxide (NaOH). After cooking the fibres detached from wood material, i.e. fibre mass, is separated from the cooking chemical, in which various binders in wood material, such as lignin and inorganic matter dissolved during cooking remain. The chemical mixture separated after cooking, i.e. black liquor, is evaporated in an evaporating plant in order to remove water and to provide a combustible material that contains as little water as possible. This material obtained from the final stage of the evaporating plant and fed for combustion may have a dry solids content of up to 85%.

Conventionally, black liquor is burned in a recovery boiler, whereby vapour, and by means of vapour electricity is produced for use as energy at the mill and optionally for sale. The inorganic part of the black liquor remaining from the combustion is removed from the recovery boiler as a molten salt, which is recycled for producing cooking chemicals. This is disclosed, for instance, in Finnish patents 82494 and 91290.

Attempts have been made to replace the recovery boiler by gasification of black liquor, for instance, but in practice it is not yet a commercially feasible solution.

WO publication 2104/005610 discloses a solution in which black liquor is pyrolyzed and the coke obtained in pyrolysis is gasified. However, this process is cumbersome in practice and it requires a separate, expensive gasification plant.

### BRIEF DESCRIPTION OF THE INVENTION

The object of this invention is to provide a method and equipment for treating black liquor, by which a recovery boiler may be eliminated from the entire process and which is simple and easy to implement mainly with the existing pulp mill apparatuses.

The method of the invention is characterized by

introducing black liquor into a pyrolysis reactor comprising a substantially oxygen-free space,

feeding into the pyrolysis reactor causticizing material that consists of sodium oxide (Na₂O) and a metal oxide (MA) and that is heated in a burning unit, whereby the black liquor is gasified and forms gaseous components and solid matter remains,

conveying the gaseous components formed in the pyrolysis reactor for further utilization,

conveying the solid matter formed in the pyrolysis reactor into the burning unit, where the combustible matter contained therein burns by means of oxygen contained in the air fed into the burning unit and causticizing material consisting of sodium oxide (Na₂O) and a metal oxide (MₓO_{y}) remains,

returning part of the causticizing material formed in the burning unit to the pyrolysis reactor and conveying part to a dissolving vat, where water is added thereto, whereby sodium hydroxide (NaOH) and metal oxide (MₓO_{y}) are formed,

returning the formed sodium hydroxide (NaOH) back to the pulping process and at least major part of the remaining metal oxide (MₓO_{y}) to the burning unit, where it forms the causticizing material with the sodium oxide (Na₂O).

The equipment of the invention is characterized by comprising:

a burning unit,

a pyrolysis reactor, into which black liquor is fed and where black liquor is pyrolysed is a substantially oxygen-free space and forms gaseous components and solid matter,

means for conveying the gaseous components formed in the pyrolysis reactor for utilization,

means for conveying the solids formed in the pyrolysis reactor to the burning unit, where the combustible material burns forming flue gases, and causticizing material consisting of sodium oxide (Na₂O) and a metal oxide (MₓO_{y}) is formed,

means for feeding part of the causticizing material heated in the burning unit into the pyrolysis reactor and feeding part into a dissolving reactor, whereby sodium hydroxide (NaOH) and metal oxide (MₓO_{y}) are formed, and

means for conveying the sodium hydroxide (NaOH) back to the pulping process and at least major part of the remaining metal oxide (MₓO_{y}) to the burning unit where it forms the causticizing material with the sodium oxide (Na₂O).

The basic idea of the invention is that black liquor is pyrolyzed by feeding the black liquor and solid causticizing material that contains metal oxide and is heated in a burning unit, preferably in a fluidized-bed boiler or a circulating fluidized bed boiler, with the black liquor into one and the same pyrolysis reactor. In the pyrolysis reactor the black liquor is heated to a suitable temperature in a substantially oxygen-free space, by means of the heat in the causticizing material, so that volatile substances in the black liquor transform to a gaseous state. When necessary, the pyrolysis reactor may be subjected to heating or cooling in order to arrange the temperature to a desired range. Further, the basic idea of the invention is that gaseous components are separated from solids and conveyed for utilization in production of electricity, for instance, and the solids, in turn, are conveyed back to the burning unit, where carbon and sodium carbonate will burn forming carbon dioxide and causticizing material, i.e. a compound of sodium oxide and metal oxide, heating at the same time the causticizing material to a desired temperature. Yet another basic idea of the invention is that part of the causticizing material formed in the burning unit is returned to the pyrolysis reactor and part is conveyed for dissolution to be mixed with water, thus forming sodium hydroxide, which is returned to the cooking process, and metal oxide, which is returned to the burning unit, where it is bound with sodium oxide and thus forms causticizing material.

The method of the invention has an advantage that one chemical cycle allows recovery of energy and chemicals. In addition, the gaseous components or the pyrolysis oil separated therefrom by condensation may be used as a substitute for a fossil fuel, or when necessary, it may be further refined to a traffic fuel. A further advantage is that the pyrolysis being fast, the formation of gases is maximized. Moreover, because the temperature in pyrolysis is lower than that in the recovery boiler, corrosion and fouling problems of the conventional recovery boilers are avoided.

### BRIEF DESCRIPTION OF THE FIGURES

The invention will be described in greater detail in connection with the attached drawings, in which

FIG. 1 shows schematically an apparatus for applying the method of the invention and

FIG. 2 shows schematically a second apparatus for applying the method of the invention.

### DETAILED DESCRIPTION OF THE INVENTION

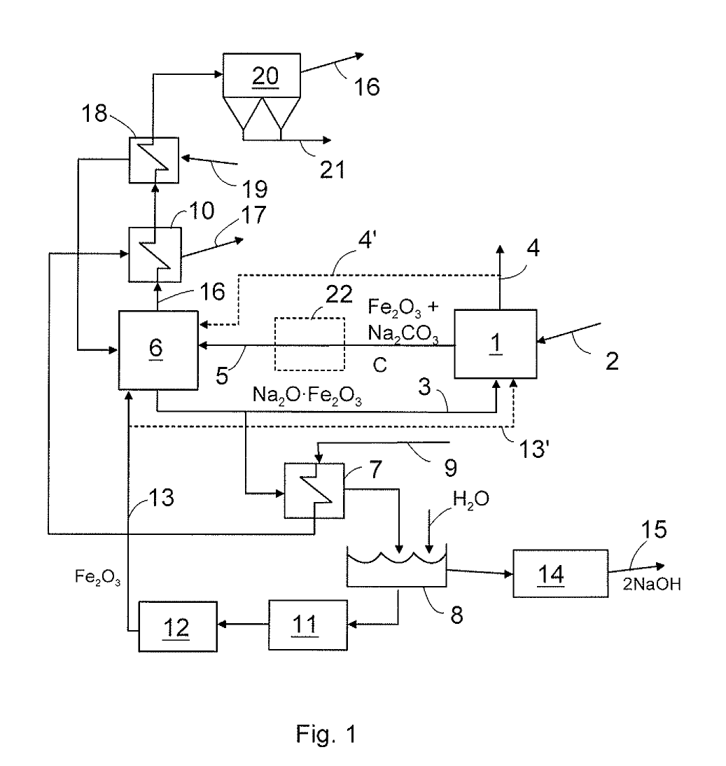

FIG. 1 shows a pyrolysis reactor 1, into which black liquor 2 is fed. Into the pyrolysis reactor 2 is also fed hot causticizing material 3 that contains a compound of sodium oxide (Na₂O) and a metal oxide, here iron oxide (Fe₂O₃) by way of example. The causticizing material heats the black liquor which is gasified in a substantially oxygen-free space into a product gas, and solid matter remains.

The product gases 4 formed in the pyrolysis reactor are conveyed for further processing and for other use. The solid material 5, which is formed in the pyrolysis reactor 1 and which contains metal oxide, in this example iron oxide (Fe₂O₃), and sodium carbonate (Na₂CO₃) and carbon (C), is conveyed for combustion in a burning unit 6, preferably a fluidized-bed boiler or a circulating fluidized bed boiler.

Combustible material obtained from pyrolysis in connection with burning in the burning unit 6, i.e. carbon and soda burn resulting in carbon dioxide (CO₂) and a solid compound (Na₂O.Fe₂O₃) of sodium oxide (Na₂O) and a metal oxide, in this example iron oxide (Fe₂O₃), which compound constitutes the causticizing material. This causticizing material is conveyed partly back to the pyrolysis reactor 1, but part of it is advantageously conveyed via a heat exchanger 7 to a dissolving vat 8. The heat exchanger 7 heats the feed water 9 for steam necessary for power production prior to its actual vaporization in a steam generator 10 to be explained later. When necessary, the heat exchanger may also be omitted and part of the material may be conveyed directly to the dissolving vat 8. Instead of one metal oxide it is also possible to use a mixture of two or more metal oxides.

In the dissolving vat 8 the sodium oxide (Na₂O) in the solid compound (Na₂O.Fe₂O₃) forms with water sodium hydroxide (NaOH) and there will remain a solid metal oxide, in this example iron oxide (Fe₂O₃), which is conveyed 13 after washing 11 and drying 12 back to the burning unit 6. The sodium hydroxide (NaOH), in turn, is conveyed after dissolving 8 through filtering 14 back to cooking 15.

Flue gases 16 which contain carbon dioxide (CO₂) and which were formed in the burning unit 6 are conveyed to the steam generator 10, into which the heated feed water 9 from the heat exchanger 7 is conveyed for being vaporized. From the steam generator 10 the formed vapour 17 is conveyed, for instance, to power production or other suitable point in the process. The steam generator as such is not necessary for the invention and, if so desired, it may be omitted.

The flue gases are forwarded from the steam generator 10 to a second heat exchanger 18, to which combustion air 19 to be fed into the burning unit 6 is conveyed. The combustion air is heated in the second heat exchanger 18 and conveyed to the burning unit 6. From the second heat exchanger 18 the flue gases 16 are further conveyed advantageously to a filter 20, where ashes 21 are separated therefrom and the flue gases are conveyed further on to a chimney or to be processed in another manner. The second heat exchanger is not necessary per se either for the invention, and if so desired, it may also be omitted.

In addition to iron oxide, also many other metal oxides behave and react in a corresponding manner, so the iron oxide may be replaced in the formula by any appropriate metal oxide. These include, among other things, titanium dioxide (TiO₂) or manganese oxide (Mn₂O₃).

In using iron oxide the direct causticizing reactions occur in the process as follows:

Fe₂O₃+Na₂CO₃=>Na₂O.Fe₂O₃+CO₂ (1)

Na₂O.Fe₂O₃+H₂O=>2NaOH+Fe₂O₃ (2)

In general presentation the formulae are of the form:

bNa₂O.cMₓO_{y}+aNa₂CO₃=>(a+b)Na₂O.cMₓO_{y}+aCO₂ (3)

(a+b)Na₂O.cMₓO_{y}+H₂O=>2aNaOH+bNa₂O.cMₓO_{y} (4)

where MₓO_{y} is a metal oxide.

Reaction (1) starts in the pyrolysis reactor and continues still in the burning unit. The iron oxide may be replaced by other suitable metal oxides, reactions being the same, in principle.

In case the temperature in the causticizing material is excessively high, the temperature of the pyrolysis reactor is to be controlled by cooling. In that case it is possible, for instance, to feed into the pyrolysis reactor part of the cool metal oxide to be mainly fed into the burning unit, which is indicated by a dashed line 13′ in FIG. 1, whereby it cools the temperature of the pyrolysis reactor to a suitable level. Temperature control may be performed, for instance, by changing the amount of iron oxide to be conveyed into the pyrolysis reactor.

The product gas 4 formed in the pyrolysis reactor may be forwarded either for direct use or to be processed in the manufacture of traffic fuel, for instance. Likewise, they may be conveyed as such for condensation so as to form in part oil and the remaining uncondensed gases may be further conveyed for use as a fuel or for another appropriate purpose. When necessary, part of the product gases may be conveyed as an auxiliary fuel to the burning unit 6, as indicated by a dashed line 4′.

The pyrolysis reactor per se may have various configurations. It may be a fluidized-bed reactor, a rotating drum or another type of reactor known per se. It is essential that it enables as good contact as possible between the black liquor and the causticizing material, and thus fast heat transfer from the causticizing material to the black liquor. The pyrolysis reactor 1 is a substantially oxygen-free space per se, the temperature of which is advantageous within the range of 400 to 600° C. Consequently, the temperature in the causticizing material to be fed into the pyrolysis reactor has to be higher than that of the pyrolysis reactor, whereby advantageously the temperature in the burning unit 6 is within the range of 600 to 1000° C. In that case, the causticizing material is correspondingly within the same temperature range, when it is removed from the burning unit and fed into the pyrolysis reactor.

In the burning unit, which most preferably is a fluidized-bed boiler or the like, carbon burns into carbon dioxide and heats it. When necessary, it is possible to burn in the burning unit additionally some other known fuel in order to provide extra heat. In this manner it is possible to burn all the carbon and utilize the energy from the carbon for heating the causticizing material. From the burning unit the formed compound of sodium oxide and metal oxide (Na₂OFe₂O₃) is conveyed, in part, to the pyrolysis reactor 1 and, in part, as earlier stated, to the dissolving vat for forming sodium hydroxide.

In some cases it may be useful to employ a separate supplementary reactor between the pyrolysis reactor 1 and the burning unit 6. This supplementary reactor 22 is denoted by a dashed line in FIG. 1. The supplementary reactor 22 allows the material to have more reaction time, whereby less non-reacted sodium carbonate (Na₂CO₃) is introduced into the burning unit, which reduces possible blocking problems resulting from melting thereof.

In the burning unit the combustion may also be carried out as oxygen combustion and the resulting carbon dioxide (CO₂) may be recovered.

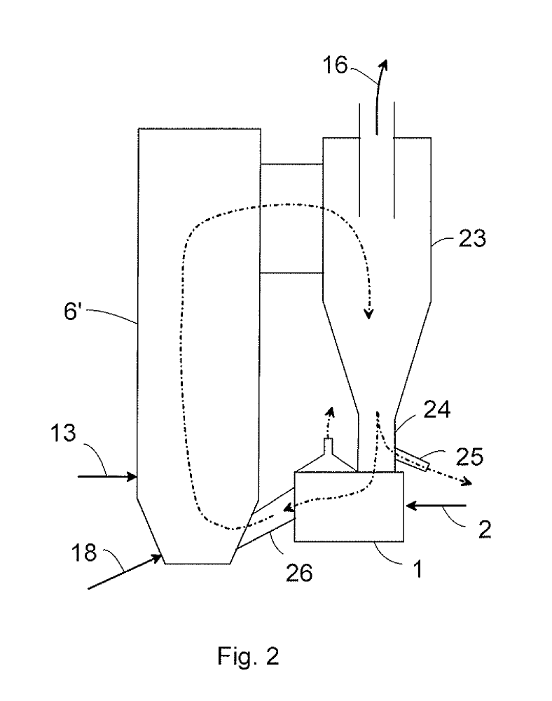

FIG. 2 shows schematically a second embodiment of the invention, in which a pyrolysis reactor 1 and a circulating fluidized-bed boiler serving as a burning unit 6 are configured to form one whole. In connection with this figure, the operation of the process is per se the same as shown in connection with FIG. 1, so all the details need not be described separately. Also, like reference numerals refer to like parts.

In this embodiment the burning unit is especially a circulating fluidized-bed boiler 6′, which is known per se to a person skilled in the art and therefore its structure and operation need not be described in detail. In that solution, circulating fluidized-bed material circulates from the circulating fluidized-bed boiler 6′, along with flue gases, to a separating cyclone 23, where solid matter is separated from the flue gases 16, which are conveyed onwards in the earlier described manner. In the separating cyclone 23 the solid matter falls onto the bottom of the separating cyclone 23 and flows therefrom further on via a channel 24 at the lower end of the separating cyclone 23 into the pyrolysis reactor 1. At the same time, part of the solid matter is separated for being conveyed via a channel 25 to the dissolving vat. From the pyrolysis reactor 1, in turn, a material feed channel 26 leads to a lower part of the circulating fluidized-bed boiler 6′, whereto combustion air 18 is also fed. The compound (Na₂O.Fe₂O₃) of sodium oxide and metal oxide is conveyed, in turn, partly in the manner described in connection with FIG. 1 to the dissolving vat, and correspondingly, from the dissolving vat, after drying and washing, the dried metal oxide is also conveyed back to the lower part of the circulating fluidized-bed boiler 6′.

This solution allows the actual causticizing reaction to have a long dwelling time in favourable conditions, which enhances the process.

The invention is described above in the specification and the relating drawings by way of example, and it is not restricted thereto in any way, but the scope of protection is defined in accordance with the attached claims. So, individual features of various working examples may be combined and applied in a desired manner to other embodiments. It is essential that the black liquor is pyrolyzed by using separate causticizing material comprising one or more metal oxides and that the solid matter formed in the pyrolysis reactor is burned so as to utilize the carbon incorporated in the black liquor in the heating of the causticizing material and that part of the causticizing material is conveyed from combustion to pyrolysis and part is conveyed to a dissolving vat wherefrom the obtained sodium hydroxy is returned to cooking and the causticizing material is returned to combustion.

1. A method for treating pulp mill black liquor in order to recover chemicals and energy contained therein, the method comprising steps of:
introducing black liquor into a pyrolysis reactor comprising a substantially oxygen-free space,
feeding into the pyrolysis reactor causticizing material that consists of sodium oxide (Na₂O) and a metal oxide (MₓO_{y}) and that is heated in a burning unit, whereby the black liquor is gasified and forms gaseous components and solid matter remains,
conveying the gaseous components formed in the pyrolysis reactor for further utilization,
conveying the solid matter formed in the pyrolysis reactor into the burning unit, where the combustible matter contained therein burns by means of oxygen contained in the air fed into the burning unit and causticizing material consisting of sodium oxide (Na₂O) and a metal oxide (MₓO_{y}) remains,
returning part of the causticizing material formed in the burning unit to the pyrolysis reactor and conveying part to a dissolving vat, where water is added thereto, whereby sodium hydroxide (NaOH) and metal oxide (MₓO_{y}) are formed,
returning the formed sodium hydroxide (NaOH) back to the pulping process and at least major part of the remaining metal oxide (MₓO_{y}) to the burning unit, where it forms the causticizing material with the sodium oxide (Na₂O).

2. The method of claim 1, wherein part of the remaining metal oxide (MₓO_{y}) is conveyed to the pyrolysis reactor.

3. The method of claim 1, wherein in the causticizing material there is used at least one of the following metal oxides: titanium oxide (TiO), iron oxide (Fe₂O₃) and manganese oxide (Mn₂O₃).

4. The method of claim 1, wherein the temperature in the pyrolysis reactor is maintained within the range of 400 to 600° C.

5. The method of claim 4, wherein the temperature in the burning unit is maintained within the range of 600 to 1000° C.

6. The method of claim 1, wherein the metal oxide (MₓO_{y}) to be conveyed to the burning unit is first washed and thereafter dried prior to conveying it to the burning unit.

7. The method of claim 1, wherein sodium hydroxide (NaOH) formed in the dissolving vat is filtered so as to separate solid matter contained therein prior to conveying it to the pulping process.

8. The method of claim 1, wherein the part of the causticizing material to be conveyed to the dissolving vat is first conveyed to a heat exchanger, where it heats the feed water used for vapour production.

9. The method of claim 1, wherein flue gases formed in the burning unit are conveyed to a vaporizing unit where it vaporizes the feed water conveyed therein.

10. The method of claim 1, wherein the flue gases formed in the burning unit are conveyed to a second heat exchanger, through which combustion air to be fed into the burning unit is conveyed, whereby the flue gases heat the combustion air.

11. The method of claim 1, wherein a fluidized-bed or circulating fluidized-bed boiler is employed as the burning unit.

12. Equipment for treating pulp mill black liquor in order to recover chemicals and energy contained therein, comprising:
a burning unit,
a pyrolysis reactor, into which black liquor is fed and where black liquor is pyrolysed is a substantially oxygen-free space and forms gaseous components and solid matter,
means for conveying the gaseous components formed in the pyrolysis reactor for utilization,
means for conveying the solids formed in the pyrolysis reactor to the burning unit, where the combustible material burns forming flue gases and causticizing material consisting of sodium oxide (Na₂O) and a metal oxide (MₓO_{y}) is formed,
means for feeding part of the causticizing material heated in the burning unit into the pyrolysis reactor and feeding part into a dissolving reactor, whereby sodium hydroxide (NaOH) and metal oxide (MₓO_{y}) are formed, and
means for conveying the sodium hydroxide (NaOH) back to the pulping process and at least major part of the remaining metal oxide (MₓO_{y}) to the burning unit where it forms the causticizing material with the sodium oxide (Na₂O).

13. The equipment of claim 12, comprising means for conveying part of the remaining metal oxide (MₓO_{y}) into the pyrolysis reactor.

14. The equipment of claim 12, wherein the causticizing material contains at least one of the following metal oxides: titanium oxide (TiO), iron oxide (Fe₂O₃) and manganese oxide (Mn₂O₃).

15. The equipment of claim 12, wherein the temperature in the pyrolysis reactor is 400 to 600° C.

16. The equipment of claim 15, wherein the temperature in the burning unit is 600 to 1000° C.

17. The equipment of claim 12, comprising means for washing and drying the metal oxide (MₓO_{y}) to be conveyed to the burning unit prior to conveying it to the burning unit.

18. The equipment of claim 12, comprising a filtering apparatus for filtering the sodium hydroxide (NaOH) formed in the dissolving vat so as to separate the solid matter therein prior to conveying it to the pulping process.

19. The equipment of claim 12, comprising a heat exchanger through which part of the causticizing material to be conveyed to the dissolving vat and the feed water to be used in vapour production are conveyed so that the causticizing material heats the feed water.

20. The equipment of claim 12, comprising a vaporizing unit, through which the flue gases formed in the burning unit and the feed water are conveyed so that the flue gases vaporize the feed water to steam.

21. The equipment of claim 12, comprising a second heat exchanger, through which the flue gases and the combustion air are conveyed so that the flue gases heat the combustion air.

22. The equipment of claim 12, wherein the burning unit is a fluidized-bed boiler.

23. The equipment of claim 12, wherein the burning unit is a circulating fluidized-bed boiler.

24. The equipment of claim 23, wherein the circulating fluidized-bed boiler includes a separating cyclone, whereto the flue gases and the causticizing material therewith are conveyed for being separated from one another, that the separating cyclone is connected at its lower end to communicate with the pyrolysis reactor therebelow so that the separated causticizing material is transferred to the pyrolysis reactor for heating the black liquor and that the pyrolysis reactor is connected to communicate with the lower part of the circulating fluidized-bed reactor so that the solids formed in the pyrolysis reactor are transferred to the circulating fluidized-bed boiler.
